(19) United States
(12) Patent Application Publication
(10) Pub. No.: US 2009/0068241 A1
(43) Pub. Date: Mar. 12, 2009

(54) DEPOSITION OF METALS ONTO NANOTUBE TRANSPARENT CONDUCTORS

(76) Inventors: David Alexander Britz, Cambridge, MA (US); Paul J. Glatkowski, Littletown, MA (US)

Correspondence Address: JAMES REMENICK;NOVAK DRUCE & QUIGG, LLP, 1300 I STREET NW, SUITE 1000 WEST TOWER, WASHINGTON, DC, 20005, US

(21) Appl. No.: 11/856,633

(22) Filed: Sep. 17, 2007

Related U.S. Application Data
(60) Provisional application No. 60/825,847, filed on Sep. 15, 2006.

(51) Int. Cl. A01N 25/08; A01P 1/00; B05D 3/14

(52) U.S. Cl. 424/409; 427/580; 210/633; 977/750

(57) ABSTRACT

This invention is directed to compositions and methods of incorporating metal particles into carbon nanotube films, sheets, and networks. Metal salts that are soluble in water, alcohol, polar organic solvents, and mixtures thereof are used to deposit metal particles onto carbon nanotube films, sheets, and networks. Metal salts increase conductance of nanotube films by spontaneously depositing gold on the nanotube. The concentration and time of exposure to metal salt solution allows the tuning of conductivity and transparency for a transparent carbon nanotube network. Metal salts added to nanotube ink add functional properties of the metal to nanotube conductors.

### REFERENCE TO RELATED APPLICATIONS

This application claims priority to U.S. Provisional Application No. 60/825,847, filed Sep. 15, 2006, entitled “Deposition of Metals Onto Nanotube Transparent Conductors,” which is specifically and entirely incorporated by reference.

### BACKGROUND

1. Field of Invention

This invention is directed to compositions and methods of incorporating metal particles into carbon nanotube films, sheets, and networks. The resulting transparent and conductive layers are useful for touch panels, LCDs, electroluminescent lamps, thin film solar cells, plasma displays, EMI shielding, electrical heaters, organic light emitting diodes (OLED), and other applications where electrical conductivity and optical transparency are desired.

2. Description of the Background

Optically transparent and electrically conductive films are known in the art. Transparent conductors (TCs) are used in touch panels, LCDs, electroluminescent lamps, thin film solar cells, plasma displays, EMI shielding, electrical heaters, organic light emitting diodes (OLED), and other applications where electrical conductivity and optical transparency are required. Such films are generally formed on an electrical insulating substrate by either a dry or a wet process. In the dry process, PVD (including sputtering, ion plating and vacuum deposition) or CVD is used to form a conductive transparent film of a metal oxide type, e.g., tin-indium mixed oxide (ITO), antimony-tin mixed oxide (ATO), fluorine-doped tin oxide (FTO), aluminum-doped zinc oxide (FZO). In the wet process, a conductive coating composition is formed using an electrically conductive powder, e.g., one of the above-described mixed oxides, and a polymer binder. The dry process produces a film having both good transparency and good conductivity. However, it requires a complicated apparatus having a vacuum system and has poor productivity. Another problem of the dry process is that it is difficult to apply to a continuous or big substrate such as photographic films or show windows. The dry process is exceptionally expensive because of the use of vacuum chambers. In addition, the dry process only results in uniform coated films. To form a highly conductive pattern, subtractive patterning techniques, such as photolithography must be used. Subtractive patterning techniques are expensive, waste materials, and are batch-oriented processes. These dry processed films typically have volume conductivities ranging from about 1,000 S/cm to about 10,000 S/cm. Typical films used for touch panels are ITO on polyester (PET) film or glass sheet with a sheet resistance (Rs) of about 300 Ohms/square to about 600 Ohms/square at about 82% to about 91% total transparency. Typical films used for LCD and OLED are ITO on borosilicate glass sheet with a sheet resistance of about 5 Ohms/square to about 30 Ohms per square at about 75% to about 90% transparency. For thin film solar cells, typical sheet resistance for ITO or aluminum doped zinc oxide on the active layer of the device is about 10 to about 30 ohms/square at about 80% to about 95% transparency.

The wet process requires a relatively simple apparatus, has high productivity, and is easy to apply to a continuous or big substrate. The electrically conductive powder used in the wet process is a very fine powder having an average primary particle diameter of 0.5 μm or less so as not to interfere with transparency of the resulting film. To obtain a transparent coating film, the conductive powder has an average primary particle diameter of half or less (0.2 μm) of the shortest wave of visible light so as not to absorb visible light, and to control scattering of the visible light. The wet process allows direct patterning by use of printing, e.g. ink jet, gravure, or lithographic printing. The wet process has several drawbacks. A significant drawback is that the conductivity and transparency achievable by wet processing is typically much worse than the dry process. Viewed another way, the volume conductivities of films produced from the wet process are much lower than the films produced by the dry process for a given optical cross-section. These wet processed films typically have volume conductivities from about 500 S/cm to about 0.5 S/cm. Typical sheet resistance of wet processed films is between about 50 Ohms/square and about 10⁹ Ohms/square A high temperature firing or annealing process sometimes is used to increase the conductivity of wet processed films. This high temperature process is typically greater than 400 degrees centigrade, which is not compatible with plastic substrates.

The development of intrinsically conductive organic polymers and plastics has been ongoing since the late 1970's. These efforts have yielded conductive materials based on polymers such as polyanaline, polythiophene, polypyrrole, and polyacetylene. (See “Electrical Conductivity in Conjugated Polymers.” Conductive Polymers and Plastics in Industrial Applications”, Arthur E. Epstein; “Conductive Polymers.” Ease of Processing Spearheads Commercial Success. Report from Technical Insights. Frost & Sullivan; and “From Conductive Polymers to Organic Metals.” Chemical Innovation, Bernhard Wessling. Intrinsically conductive polymers are capable of being wet processed. A commercially available conductive polymer is polyethylene dioxythiophene doped with polystyrene sulfonic acid (PEDOT:PSS). PEDOT:PSS is capable of being printed and deposited from solution at low temperatures and at a high rate of throughput. However, the material itself has low volume conductivity, typically less than 300 S/cm and more typically less than 10 S/cm. Also, PEDOT:PSS is purple in color and absorbs a significant amount of light at a useful conductivity for a transparent electrode. Typical sheet resistance of PEDOT:PSS is about 1,000 Ohms/square to about 1010 Ohms/square.

A significant discovery was that of carbon nanotubes (CNT), which are essentially single graphite layers wrapped into tubes, either single walled nanotubes (SWNTs) or double walled (DWNTs) or multi walled (MWNTs) wrapped in several concentric layers. (B. I. Yakobson and R. E. Smalley, “Fullerene Nanotubes: C.sub.1,000,000 and Beyond”, American Scientist v.85, July-August 1997). Although only first widely reported in 1991, (Phillip Ball, “Through the Nanotube,” New Scientist, Jul. 6, 1996, p. 28-31), carbon nanotubes are now readily synthesized in gram quantities in laboratories all over the world and are also being offered commercially. The tubes have good intrinsic electrical conductivity and have been used in conductive materials.

Glatkowski (U.S. Pat. No. 7,060,241) has demonstrated that networks and films of carbon nanotubes can be electrically conductive and optically transparent. These films have the benefits of wet processing, but the electrical conductivity of dry processed films. Specifically, water-based dispersions of carbon nanotubes are deposited onto a substrate using a wide range of printing techniques. The inks are dried, leaving a film of carbon nanotubes. This film is electrically conductive and optically transparent. Typical carbon nanotube (CNT) films on PET or glass are between 90% transparent and 98% transparent at 500 Ohms/square. These films are typically less than 50 nm thick. Their volume conductivity is typically between about 1,000 S/cm and about 10,000 S/cm. This sheet resistance and transparency is similar to ITO. The amount of CNT used is minimal and the CNT is deposited at low temperature using wet processing, so the cost of CNT films at about 500 Ohms/square is low. This material is commercially competitive with ITO for touch panels and electroluminescent lighting.

Carbon nanotube films differ from transparent conductive oxide films like ITO in the mechanism of light loss. Most of the light that is not transmitted through a CNT film is absorbed by the CNT. Thick CNT films are black and opaque. Most of the light that is not transmitted through an ITO film is reflected by the ITO surface and some light is absorbed by the material. Thick ITO films are yellow reflective. Typically, CNT films thicker than 50 nm begin to be very dark and transmit less light. To make CNTs useful for high transparency, low sheet applications like LCD, solar cell, and OLED electrodes, the volume conductivity of CNT films should be increased. Thickness of the CNT film should preferably be kept low to minimize transparency loss, while conductivity should preferably be increased to lower sheet resistance. High temperature treatments and vacuum (dry) processes are generally not desired because they are expensive, slow, and not compatible with plastic or flexible substrates.

Previous reports indicated that aurate salt precipitates onto the sidewalls of carbon nanotubes through a charge transfer reaction. This reaction caused individual carbon nanotubes to become strongly p-doped due to charge transfer, as determined by field effect transistor measurements. However, no careful study has been undertaken to establish whether the local deposition of gold is due to defects, strain, or some other driving force associated with the CNT structure.

In addition to optical transparency and electrical conductivity, it is desired to have multifunctional coatings that can conduct electricity and transmit light and also have the capability to be sanitary or antimicrobial. These coatings find applications in touch panels in public places (e.g. ATMs) electronic door switches in hospitals, medical devices, antistatic coatings on plastic, clean rooms, mobile phones, solar cells in hot and humid places, damp and dark environments that grow mold, and spacecraft that are designed to interact with life forms. In the past decade, scientists and clinicians have found that bacteria in the environment often live in highly organized communities called biofilms. Biofilm formation is recognized as the leading culprit in many life-threatening infections. Most known pathogenic organisms have the potential of creating biofilms. Once established, biofilms are difficult to eliminate from the surface of devices.

One method under investigation to prevent biofilms and to kill microbes is to incorporate antimicrobial properties into devices and coatings. The theory is that the antimicrobial treatment discourages the establishment of biofilms. Manufacturers are increasingly looking toward silver as the answer. Silver is one of the oldest known antimicrobials. Antimicrobial silver is now used extensively to combat organisms in wounds and burns. It works because pathogens cannot mutate to avoid its antimicrobial effect. In the process of developing burn and wound silver technologies, researchers have studied the ability of silver's antimicrobial properties to remain effective in the face of virulent pathogens. Silver ions kill microorganisms. When silver ions dissolve from a silver particle into a fluid, silver provides an antimicrobial action. The positively charged ionic form of silver is highly toxic for microorganisms but has relatively low toxicity for human tissue cells.

Silver works in a number of ways to disrupt critical functions in a microorganism. For example, it has a high affinity for negatively charged side groups on biological molecules. These include groups such as sulfhydryl, carboxyl, phosphate, and other charged groups distributed throughout microbial cells. This binding reaction alters the molecular structure of the macromolecule, rendering it worthless to the cell. On the other hand, CNTs decorated with negatively charged groups, such as carboxyl groups, are likely to hold silver ions and precipitate silver particles. This interplay between CNT functional groups and microbe functional groups creates a powerful anti-microbial defense.

Silver simultaneously attacks multiple sites within the cell to inactivate critical physiological functions such as cell-wall synthesis, membrane transport, nucleic acid (RNA and DNA) synthesis and translation, protein folding and function, and electron transport, which is important in generating energy for the cell. Without these functions, the bacterium is either inhibited from growth or, more commonly, the microorganism is killed. Because silver affects so many different functions of the microbial cell, it is nonselective, resulting in antimicrobial activity against a broad spectrum of medically relevant microorganisms including bacteria, fungi, and yeasts. Silver is also more efficient than traditional antibiotics because it is extremely active in small quantities. For certain bacteria, as little as one part per billion of silver may be effective in preventing cell growth.

Because biofilm formation is dependent upon the availability of a surface, one strategy is to modify the surface to make it hostile to microorganisms. Ionic and colloidal or particulate silver is becoming a favored substance for surface modification because it has broad-spectrum antimicrobial action, it is well tolerated by tissues, and it is compatible with most materials used in making medical devices and films.

Surface-application chemistries vary, but they are usually designed to deposit either metallic silver or an ionic salt of silver to the surface. Both forms are activated when placed in the presence of moisture. The limitation of ionic salts is that they are only active for a short period of time-often only for a few days. By contrast, metallic silver nanoparticles persist in delivering antimicrobial silver for as long as 100-200 days. Nanosilver particles (as small as 1000th the diameter of a bacterium) constitute the reservoir for the antimicrobial effect. This reservoir effect results when metallic silver, which has no antimicrobial properties, undergoes oxidation, which results in the release of the ionic form. This chemical reaction occurs at the surface of the particle when it is exposed to moisture such as body fluids. Silver metal oxidizes slowly, so most of the silver metal persists on the surface to extend its usefulness.

Because silver does not readily oxidize, nanoparticles are critical to achieving a large number of silver ions. The smaller the particle size, the greater the ratio of surface area to volume, and the greater the area available for oxidation and the more ions available for antimicrobial action. CNT networks are open-pore networks, so silver can be deposited throughout a CNT network, and all the silver surface area is accessible.

### SUMMARY OF THE INVENTION

The present invention overcomes the problems and disadvantages associated with existing nanotube coatings and designs, such as unstable conductive and/or optical properties, or instability to environmental conditions such as humidity, heat, or UV radiation, by incorporating metal particles within carbon nanotubes used on conductive and transparent thin films.

One embodiment of this invention is directed to an antimicrobial, electrically conductive and optically transparent film comprising single-walled carbon nanotubes and a sub-percolation threshold amount of metal particles that have a diameter below 200 nm, below 100 nm, below 50 nm or below 10 nm, wherein the metal particles impart significant electrical conductivity to the film. In certain embodiments, the metal is silver. In certain embodiments, the metal particles release ions that are toxic or static to growth or survival of pathogens, bacteria, or viruses. In certain embodiments, a surface of the film is toxic to pathogens, bacteria, or viruses.

Another embodiment is directed to an electrically conductive and optically transparent film, comprising a network of single-walled carbon nanotubes and a sub-percolation threshold amount of metal particles that have a diameter below 200 nm, wherein the metal particles impart significant electrical conductivity to the film. In preferred embodiments, the carbon nanotubes form ropes, bundles, or combinations thereof. Preferably, the metal particles decrease surface resistance of the network by between 10% and 20%, by between 10% and 50%, by between 30% and 50%, or by between 50% and 90%. Preferably, the metal particles decrease visible light transmittance of the network by 10% or less, 5% or less, 1% or less, or 0.05% or less. In certain embodiments, the metal particles improve the network's sheet resistance stability, heat stability, UV stability, humidity stability, abrasion resistance, or combinations thereof. In certain embodiments, the metal particles improve mechanical connectivity, electrical connectivity, or combinations thereof, between the carbon nanotubes. In a preferred embodiment, the metal particles are gold particles and are from 1 to 200 nm in diameter, wherein sheet resistance of the film is less than 200 ohms/square, and wherein visible light transmittance of the film is greater than 80%.

Another embodiment is directed to a method of making a transparent conductive film comprising: contacting a network of carbon nanotubes with a metal salt; and applying an electrical potential to the network, wherein the electrical potential overcomes the chemical potential of the metal salt; resulting in a sub-percolation threshold amount of metal particles from the metal salt being deposited or precipitated onto the network, wherein the metal particles have a diameter of 200 nm or less and impart significant electrical conductivity to the film. In certain embodiments, the metal is gold, silver, palladium, platinum, copper, chromium, nickel, manganese, iron, aluminum, an alkaline earth metal, an alkali metal, a transition metal, a lanthanide, a poor metal, an actinide, or combinations thereof. In certain embodiments, the metal salt is in a solution comprising a polar solvent, a polar protic solvent, an alcohol, methanol, water, a mixture of alcohol and water, or combinations thereof. In certain embodiments, the electrochemical potential is an electrical reducing potential that facilitates deposition of the metal particles onto the network. In certain embodiments, the electrochemical potential is an electrical oxidative potential that inhibits the deposition of the metal particles onto the network. In certain embodiments, the contacting of the network with the solution comprises dipping, wet-coating, gravure printing, inkjetting, bubble jetting, spraying, or combinations thereof. In certain embodiments, the contacting of the network with the solution comprises depositing the metal particles in a pattern onto the network.

Another embodiment is directed to a colloidal dispersion comprising single-walled carbon nanotubes substantially formed into ropes and a metal salt in a solvent, wherein the metal salt is reduced by the carbon nanotubes to form metal particles that are deposited onto the carbon nanotubes, wherein the metal particles have a diameter below 200 nm. In certain embodiments, the solvent is selected from the group consisting of a polar solvent, a polar protic solvent, an alcohol, methanol, water, and combinations thereof. In certain embodiments, the metal salt is soluble in the solvent. In certain embodiments, the metal particles and the carbon nanotubes are present in a weight percent ratio of 2.5:1, 1:1, 1:5, 1:10, or 1:100 metal particles to carbon nanotubes. Another embodiment is directed to a method of producing an electrically conductive and optically transparent film comprising depositing the dispersion according to certain embodiments of this invention onto a substrate.

Another embodiment is directed to a method of removing impurities from a dispersion comprising single-walled carbon nanotubes, comprising: adding a metal salt that preferentially precipitates onto said impurities and increases the density of the impurities; removing the impurities onto which the metal salt precipitated by centrifugation and decantation, by filtration, by magnetic separation, or by a chemical reaction. In certain embodiments, the impurities comprise amorphous carbon, graphite, catalyst, damaged carbon nanotubes, organic particles, ionic contaminations, or combinations thereof.

Other embodiments and advantages of the invention are set forth in part in the description, which follows, and in part, may be obvious from this description, or may be learned from the practice of the invention.

### DESCRIPTION OF THE FIGURES

FIG. 1 is a schematic diagram of a preferred method of coating CNT films with metal nanoparticles.

FIG. 2 is a diagram depicting concentration versus drop in sheet resistance for all samples dipped in methanol solutions. Note that dip times vary from one to ten minutes. The average change is sheet resistance for each molarity is shown independent of dip time.

FIG. 3 depicts change in transparency (blue) and change in sheet resistance (green) versus dip time for 0.75 mM HAuCl₄ solution in MeOH. Note that the change in % T (transparency) axis varies from 0.5% to −4%, and the change in Rs (sheet resistance) axis varies from −15% to −40%.

FIG. 4 depicts change in transparency (blue) and change in sheet resistance (green) versus dip time for 2.0 mM HAuCl4 solution in MeOH. Note that the change in % T axis varies from 1% to −25%, and the change in Rs axis varies from 40% to −40%.

FIG. 5 depicts 1,000× magnification images of a CNT slide dipped in 5 mM HAuCl4 in MeOH (a) for 5 minutes and (b) for 10 seconds.

FIG. 6 is a schematic diagram representing change in resistance versus dip time and change in transparency versus dip time. Time is approximately a log scale, indicating the first step occurs rapidly, and the following two steps occur over successively longer times.

FIG. 7 depicts a SEM micrograph of a gold particle coated sample.

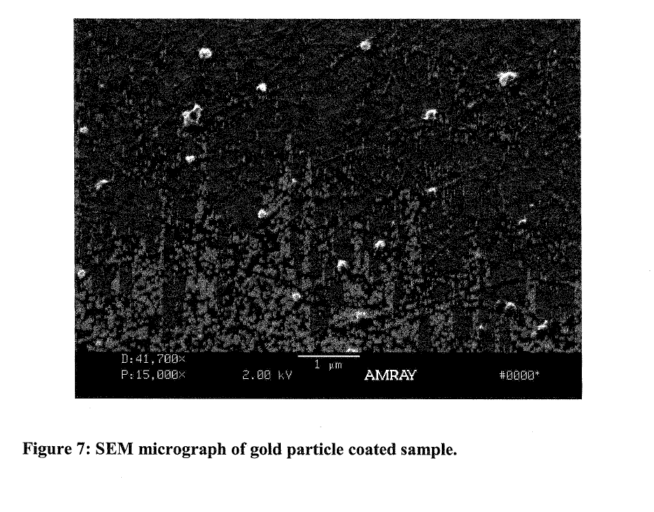

FIG. 8 depicts a 1,000× magnification image of palladium coated CNT film.

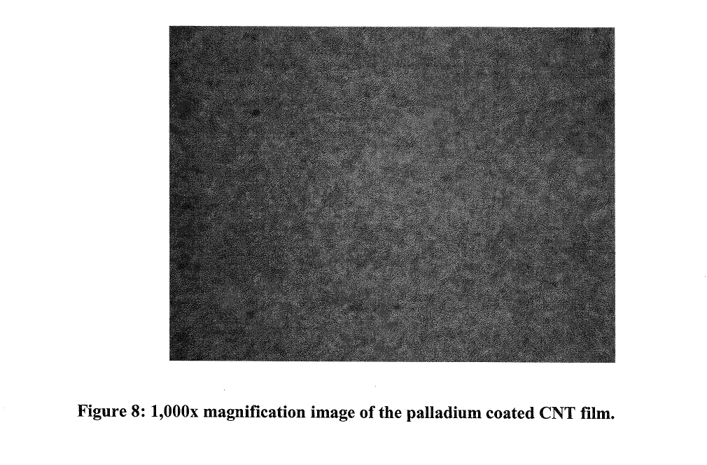

FIG. 9 depicts a ratio of gold to SWNT by weight versus renormalized transmittance at 500 Ohms per square. The line is to guide the eye.

### DESCRIPTION OF THE INVENTION

It was surprisingly discovered that electrochemical deposition of metals onto conductive transparent CNT films and networks is a beneficial way to improve conductivity of the CNT film while minimally affecting transparency. Electrochemical deposition is controlled, at least in part, by applying a potential to the CNT network exposed to a metal salt solution. Additionally, by the process of the invention, metal spontaneously deposits onto the CNT network when the electrochemical potential of the CNT network causes spontaneous precipitation or deposition from the metal salts.

Two specific aspects of this invention are novel and unexpected. First, prior art has demonstrated that removal of metal particle improves the conductivity of nanotube networks. Metal particles typically are present in as-produced carbon nanotubes as residual catalyst. These particles are considered impurities and hinder the formation of conductive nanotube networks. Additionally, these particles are composed of a high weight percent of metal oxide, which are typically non-conductive materials. Therefore it was unexpected that formatting metal particles on nanotube networks would improve conductivity. It was surprisingly discovered that depositing metal particles by precipitating metal from a metal salt onto carbon nanotubes through a redux reaction significantly increased conductivity of a carbon nanotube-containing film while preserving transparency. Second, it was surprising and unexpected to observe a large increase in conductivity of a CNT network with the deposition of metal particles significantly below the percolation threshold. If a greater number of particles were deposited, it is obvious that transparency would suffer significantly. It was surprisingly discovered that small particles (less than 200 nm) well below the percolation threshold do not significantly decrease optical transparency, but do significantly increase electrical conductivity because of a beneficial nanotube-metal interaction at the nanoscale. Ref: Mikhail E. Itkis, Ferenc Borondics, Aiping Yu, and Robert C. Haddon, Nano Lett., 7 (4), 900-904, 2007

Preferably, the metal particles deposit from salt in such a matter that their optical cross-section is about less than 200 nm on average or at least in part to not interact with visible light and thus to not affect transparency. Without wishing to be bound by theory, these metal particles increase the volume conductivity of the CNT network several ways. First, the particles act to withdraw electronic density from semiconducting carbon nanotubes, making them more doped. Second, metals deposit at defects and provide alternative low-energy conductive pathways for charges to pass through the film. Third, metal particles bridge tube-tube junctions and reduce the resistance between tubes. Fourth, the presence of metals fills the pores of the CNT network with a material that has high intrinsic volume conductivity. The volume conductivities of silver, copper, and gold are 6.301×10⁵ S/cm, 5.96×10⁵ S/cm, and 4.521×10⁵ S/cm, respectively, which are higher than the conductivity of the CNT network. If the total amount of metal remains low, then the effect on transmission is low. This method enables CNT sheet resistance to be useful as an electrode for applications like LCD, plasma, EMI shielding, solar, and OLED.

In a preferred embodiment, metal is deposited from solution of a metal salt onto a carbon nanotube network. Examples of metal salts include transition metal salts, precious metal salts, lanthanide salts, metal salts containing chloride, metal salts containing nitrates, K₂Cr₂O₇, AgNO₃, VCl₃, SbCl₃, CuCl₂, CoCl₂, NiCl₂, ZnCl₂, Cr(NO₃)₃, FeCl₃, TiCl₄, and AI(NO₃)₃, AgNO₃, HAuCl₄, KAuCl₄, K₂PtCl₄, K₂PdCl₄, combinations thereof. In another preferred embodiment, gold is deposited onto a nanotube network from gold salt solution. In another preferred embodiment, silver is deposited onto a nanotube network from silver salt solution.

Deposition of the metal is driven by the electrochemical potential of the CNT film. Preferably, this electrochemical potential spontaneously drives the deposition of the metal; more preferably, an electrochemical potential is applied to the CNT film to cause deposition of metal.

Preferably, the solvent is, for example, a polar solvent, a polar protic solvent, an alcohol, methanol, water, a mixture of alcohol and water, or combinations thereof.

In a preferred embodiment, the metal salt solution is deposited onto the CNT film by dipping the CNT film in the metal salt solution. In another preferred embodiment, the metal salt solution is deposited onto the CNT film by wet-coating the metal salt solution onto the CNT film. In another preferred embodiment, the metal salt solution is deposited onto the CNT film by gravure printing of the metal salt solution onto the CNT film. In another preferred embodiment, the metal salt solution is deposited onto the CNT film by inkjet, bubble jet, or spraying the metal salt solution onto the CNT film. In a preferred embodiment, the metal salt solution is deposited onto the CNT film in a pattern. In another preferred embodiment, the metal salt solution is deposited onto the CNT film in a pattern to selectively improve the conductivity of the CNT network.

In a preferred embodiment, metal salts are added to carbon nanotube film forming dispersions, or carbon nanotube inks. In a further preferred embodiment, metal salts are added to nanotube inks in water and alcohol mixtures. In a further preferred embodiment, the metal salt is soluble in the solvent in which the carbon nanotubes are dispersed. In a most preferred embodiment, the metal salt converts to metal in the presence of CNT, and, preferably, the metal deposits on the dispersed CNT.

In a preferred embodiment, about equal weight percentages of CNT and metal from the metal salt are present in the film forming liquid. In another preferred embodiment, between about a ratio of 2.5:1 and 1:1 metal to nanotube is present in the film forming liquid. In another preferred embodiment, between about a ratio of 1:5 and 1:10 metal to nanotube is present in the film forming liquid. In another preferred embodiment, between about a ratio of 1:10 and 1:100 metal to nanotube is present in the film forming liquid.

In one embodiment, metal salts are added to film former containing CNT and impurities, such as amorphous carbon, graphite, catalyst, damaged CNT, organic contamination, ionic contamination, or combinations thereof. In this embodiment, the metal salts selectively precipitate onto impurities and cause the density of the impurities to increase. In a further preferred embodiment, the dense impurity is removed by centrifugation and decantation of the supernatant, by filtration, by magnetic separation, or by a selective further reaction.

In a preferred embodiment, the deposition of metal particles onto the CNT increases functional properties of the CNT film. Preferably, the deposition of metal particles onto the CNT increases the conductivity of the CNT network, preferably by between 10% and 50%. Preferably, the deposition of metal particles onto the CNT decreases sheet resistance of the CNT network by between 10% and 20%, more preferably by between 10% and 50%, more preferably by between 30% and 50%, or most preferably by between 50% and 90%.

In preferred embodiments, the deposition of metal particles onto the CNT does not decrease broad spectrum transmittance. Preferably, transmittance in the visible region is not reduced. In certain embodiments, deposition of metal particles onto the CNT decreases transmittance in the visible region by between about 5% and 10%, or more preferably by between 0.05% and 5%.

In a preferred embodiment, the deposition of metal particles onto the CNT improves the mechanical robustness of the CNT film, such as abrasion resistance of the CNT film. In preferred embodiments, the metal particles bridge CNTs and/or CNT ropes or bundles (ropes or bundles being the preferred configuration of CNTs on films in preferred embodiments of this invention so as to optimize conductivity), to improve mechanical and electrical connectivity between the nanotubes.

In one embodiment, the metal particles precipitated onto the CNT network facilitate a chemical reaction. In a preferred embodiment, the metal particles release ions that are toxic to pathogens, bacteria, or viruses. In another preferred embodiment, the metal particle surface is toxic to pathogens, bacteria, or viruses. In a further preferred embodiment, the metal particles comprise silver.

In another embodiment, the metal particle acts as a catalyst to increase the rate of a chemical reaction or create a product that is not favorable without the presence of a catalyst. Preferably, the metal comprises platinum or palladium. In a preferred extension of these embodiments, the catalyst or antimicrobial particles are deactivated by applying a bias to the CNT network. The particles are activated reversibly and repeatably by applying a reverse bias. In a further preferred embodiment, the application of a bias to the CNT network cleans the particles and increases their surface activity after cleaning. In a further preferred embodiment the progress of the chemical reaction is monitored through the transparent conductive CNT film by the use of spectroscopic methods, for example by infrared spectroscopy.

In preferred embodiments, the deposition of metal particles onto the CNT improves sheet resistance stability, heat stability, UV stability, humidity stability, or combinations thereof, of the CNT-metal particle film.

The following examples illustrate embodiments of the invention, but should not be viewed as limiting the scope of the invention.

### EXAMPLES

### Example 1

### Nanoparticle Deposition to Improve Conductivity and RT Performance

Nanoparticle precipitation from salt solutions of gold, platinum, palladium, and 2 nm colloidal gold were examined in this example. The chemical reactions are:

HAuCl₄⁺CNT→CNT-Au nanoparticle film+HCl+Cl₂

K₂PtCl₄⁺CNT→CNT-Pt nanoparticle film+KCl+Cl₂

Na₂PdCl₄⁺CNT→CNT-Pd nanoparticle film+NaCl+Cl₂

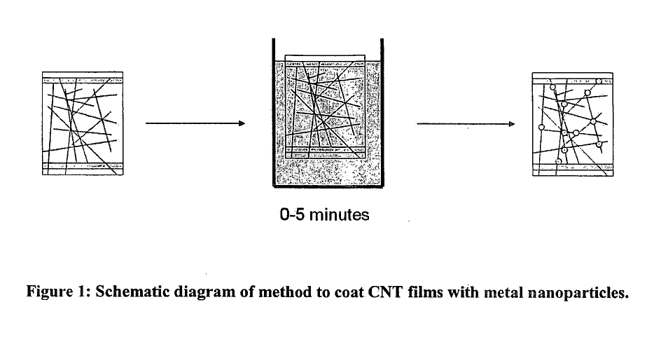

Generally, CNTs were spray coated from water and alcohol onto glass slides to make transparent conductive coatings. For this example and other examples, the CNTs used were single walled carbon nanotubes. CNT coated slides were dipped for 0 to 60 minutes in a metal salt solution (FIG. 1). More typically, dip times were kept to less than five minutes. Occasionally, the samples were rinsed after dip coating, but the rinsing process was observed to cause visible tears in the CNT film. Since macroscopic tears inevitably affect sheet resistance and do not accurately portray the microscopic changes of the sample, rinsing samples was avoided in order to decrease loss of samples. Un-rinsed samples retained some metal salt, which can adversely affect transparency, especially if the colored salt solution does not dry uniformly.

Literature reports on procedures use 1:1 water to ethanol mixtures, but this solvent mixture did not dry uniformly, leaving colored blotches of metal salt on the coating, thereby reducing transmittance. To avoid rinsing, dip solvents such as methanol, water and isopropanol were chosen that would not leave metal salt spots.

### Example 2

### Depositing Gold Particles from Aurate Salts

It was surprisingly discovered that HAuCl₄ was soluble in a range of alcohols up to high concentrations (>20 mM), making it one of the more versatile metal salts. Aurate salt solutions were bright yellow in all solvents. A 5 mM solution of HAuCl₄ was prepared in 1:1 water to ethanol. Several CNT samples were immersed in the solution for a varying length of time, from <1 second to 10 minutes. Once dried, it was observed that the sheet resistance dropped from 15% to 42%. In initial experiments, the change in sheet resistance could not be correlated to changes in transparency, since the 1:1 water to ethanol solution did not dry evenly on the sample, leaving streaks and salt marks. Also, the solution caused the CNT film to delaminate and tear for some samples upon drying. This effect clearly muted some of the Rₛ, improvement from the aurate salt solution. Additionally, the solution appeared to have an adverse effect on the mechanical properties of the silver electrodes. Frequently, the electrodes would peel off the glass substrate, requiring the test to be repeated.

### Example 3

### Optical Uniformity Improvement with Different Solvents

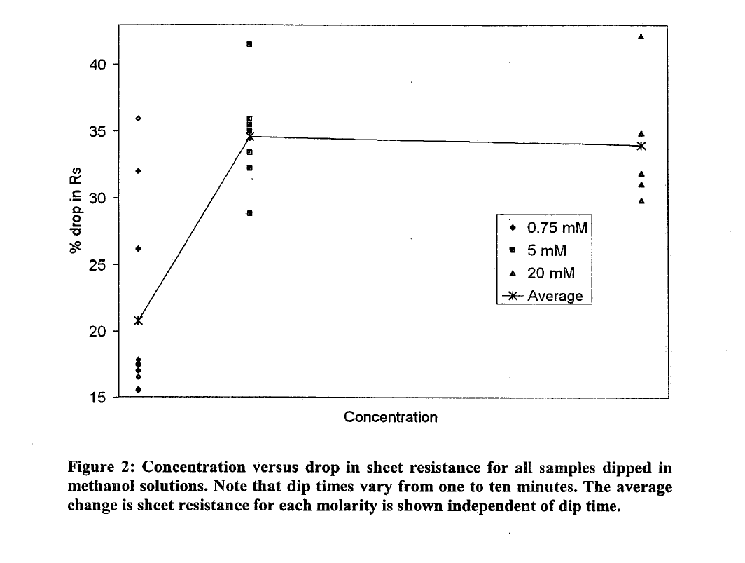

To improve on the observed water spots, the dip solvent was changed to methanol, which dries quickly and wets evenly the CNT coated glass. Also, the effect of the concentration of the salt solution on optical uniformity of the coated sample was studied. High aurate salt concentrations had shorter dip times, but caused a high degree of nonuniformity in the sample; more gold precipitated in close proximity to the electrodes due to a different electrochemical potential close to the electrodes. Lower concentration solutions gave a more uniform coating across the length of the sample. The uniformity is improved at low concentrations due to less residual metal salt remaining on the sample upon removal from the dip bath. A concentration dependence was found on the range of Rₛ, improvement for dip times less than 5 minutes (FIG. 2). Specifically, low concentrations resulted in a smaller improvement in RT performance. This result is unsurprising, since lower concentration solutions have slower reaction kinetics than high concentration solutions.

### Example 4

### Reduction of Sheet Resistance with Longer Dip Times

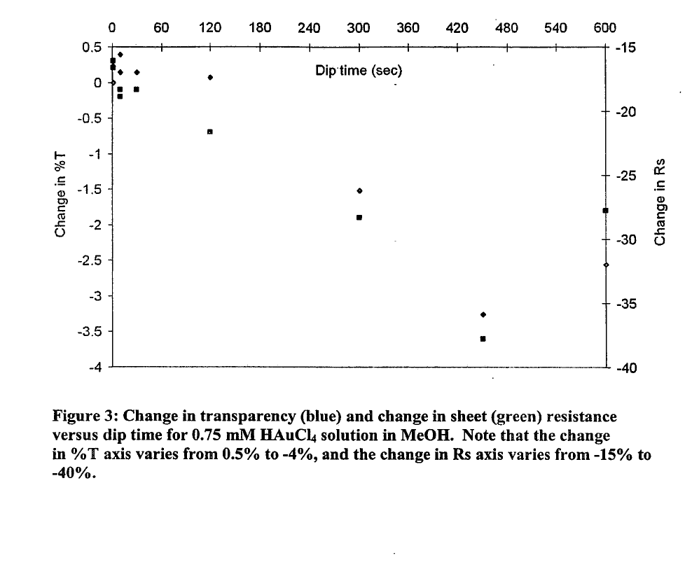

The dependence of dip time on Rₛ, improvement and on optical transparency for samples dipped in 0.75 mM HAuCl₄ solutions (FIG. 3) was evaluated. As expected, the transmittance decreased when samples were left in the dip solution for longer times.

Rapidly dipped samples showed an increase in transparency due to gentle cleaning or removal of contaminant from the sample, while the multiple minute dips showed a drop of up to absolute 1.9% T. It appeared that the sheet resistance dropped over a fairly tight range for samples (15.6-17.7%) dipped less than two minutes. However, longer sample dips showed Rₛ, drops of up to 36% at a penalty of ca. 3.5% T.

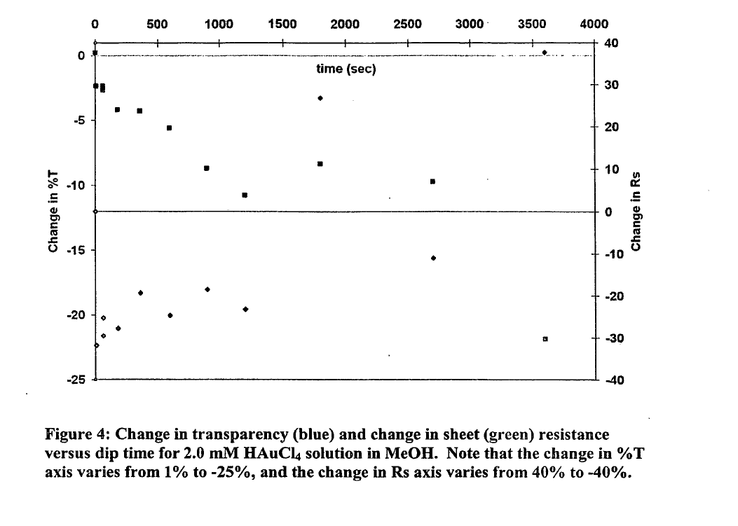

For longer dip times (>5 minutes), gold precipitation was visible to the naked eye on the film. Higher solution concentrations (2 mM, 5 mM and 20 mM) and longer dips did not appear to offer any significant advantage in conductivity, but considerable loss in transparency (FIG. 4) due to film damage.

A 2 mM solution of aurate salt was used as a bath solution for freshly sprayed CNT samples around 500 Ohms/sq. This experiment differed from the one above in two ways: the solution concentration was 2⅔ times that of the previous experiment, and the dip times were significantly increased. The data presented above shows that sheet resistance does not continue to improve after initial decreases of ca. 30%. Small tears in the film were observed upon close examination of the film after dipping. These tears undoubtedly caused an increase in sheet resistance, even if the local conductivity of the CNT film increased. As seen from the transparency measurements, gold continued to deposit onto the CNT film for an hour. The samples with heavy gold deposition appeared to be yellowish in color and hazy. The lowest obtained sheet resistance was measure to be about 160 ohms/square with a transparency of about 85%.

### Example 5

### Optical Appearance of Gold Particle Coated Films

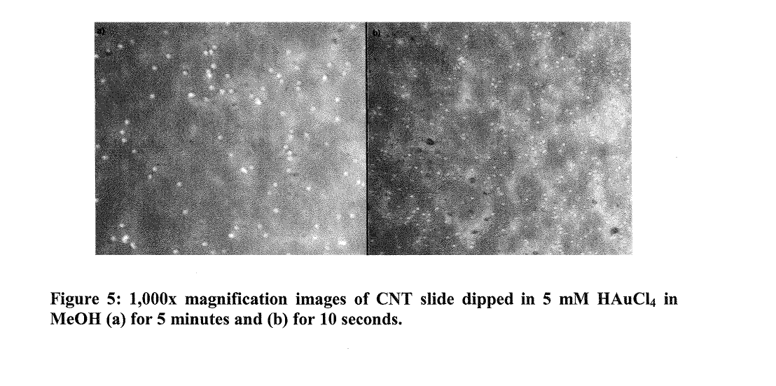

CNT films dipped in 5 mM HAuCl₄ solution in MeOH for 10 seconds and for 5 minutes were examined. The two films had visibly different appearances: the 10 second dip film showed only a 0.6% decrease in transparency, whereas the 5 minute dip film showed a 6.6% decrease in transparency with visible non-uniformity in gold deposition; the areas near the electrodes appeared to preferentially deposit gold. The sheet resistance of the 10 second dip fell by 26%, whereas the 5 minute dip dropped 33%. In terms of RT performance improvement, clearly the 10 second dip is favorable; the 5 minute sample renormalized to a 92.2% T at 500 Ohms, whereas the 10 second dip renormalized to 94.1% T at 500 Ohms. The samples were examined using optical microscopy to determine morphology differences (FIG. 5).

The morphology of the gold coatings is similar for different dip times, but presents notable differences. In both cases, the CNT film shows up as grey, with the gold particles appearing as yellow metallic, reflective quasi-circles. The arrangement of the gold particles appeared random near the center of the sample. Up to several millimeters from the electrodes, some slides showed gold particles precipitating in high concentration and along preferred directions. These sites served as nucleation points for the gold particles due to incomplete cleaning of the slide surface or due to a change in the electronic structure of the CNT close to the electrode. Also, examination of basked silver electrodes shows that silver sloughs off the electrode and deposit on the slide near the electrode.

Based on our optical microscopy work, we found that the size of particle deposited onto the nanotube increased with increasing time. As seen in FIG. 5b, the 10 second dip has small particles that are close to 200 nm in diameter, which is the resolution limit of the optical microscope. Particles smaller than 200 nm were not seen with an optical microscope. Longer dips resulted in larger particles that were found to be approximately 1 micron in diameter (FIG. 5a). These particle sizes are surprisingly much larger than those observed in the literature, despite using similar dip times and concentrations. If concentration is invariant, then larger particles arise from CNT film of embodiments of this invention having a greater electrochemical potential. The presence of submicron contaminants also serves as nucleation sites. Submicron particles have been observed in our nanotube films previously. These sites serve as the dominant mechanism for loss of transmittance, whereas much smaller particles that do not interfere with light are contributing to conductivity. Thus, when the particles are removed, conductivity improves dramatically, whereas transmittance will not change.

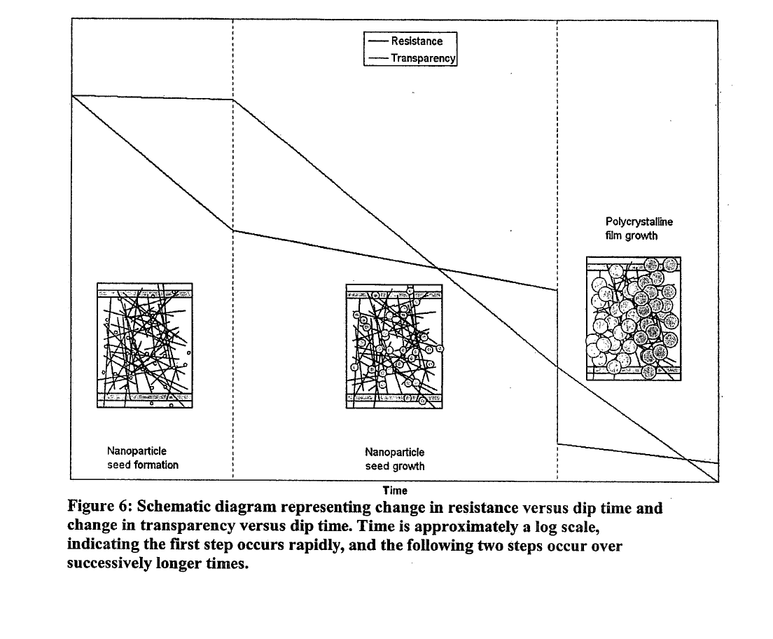

Frequency of particles is high but varies over a large range. Qualitative analysis shows the loss of transmission of the film is not due to deposition of new particles with time. Rather, the loss of transmission is more likely due to the original gold particles growing progressively larger with time. This growth mechanism has implications for the change in sheet resistance and transparency (FIG. 6).

There is a three step mechanism for changes in resistance and transparency of CNT films with gold particle precipitation. The first step involves the formation of “nanoparticle seeds” on favorable sites on the CNT film. These sites are sidewall defects, CNT ends, amorphous carbon, nanotube sidewalls, or combinations thereof. Transparency changes very little during this phase, but conductivity shows marked improvements because of local deposition of conductive additives with a diameter less than the wavelength of light. Once these sites have been occupied by a gold nanoparticle, they serve as nucleation sites for further gold precipitation, leading to increased nanoparticle size. Resistivity continues to drop, but not as precipitously as in step one. Transparency decreases substantially, since the particle size begins to be large enough to scatter light and the optical cross section of the particles begins to be significant. The nanoparticles continue to grow until they reach the next step, where the particles become sufficiently large to create conduction pathways directly through the gold; this stage is effectively the percolation threshold for conductivity through the colloidal particles. Once the percolation threshold is met, the resistance drops substantially. These films maintain some transparency due to nonuniform particle coverage and the thin layer of deposited particles. As the particles grow, the transparency continues to decrease until the gold film is effectively a polycrystalline film. An electrochemical potential will bring the final stage to completion, depending on the metal.

Optical and scanning electron microscope examinations of the films showed the absence of bacteria, fungus, pathogens, microbes, or other forms of living microscopic biological matter.

### Example 6

### Platinum Nanoparticle Precipitation Experiments

It was attempted to precipitate platinum and palladium nanoparticles from their respective salts. The platinate salt was difficult to work with, since it has a low solubility in water and practically no solubility in alcohol. Additionally, platinate solutions with a fraction of alcohol spontaneously precipitated as platinum colloid several hours after preparation of the solution, limiting the length and number of experiments for a batch of solution. Platinate salt forms dark red solutions in water, but turn to grey, metallic suspensions when left in the dark under ambient conditions. CNT slides dipped into 5 mM aqueous palatinate solution showed no change in sheet resistance or in transparency. The lack of change in conductivity and transparency indicated that no platinum precipitated onto the CNT network. Longer dipping times resulted in some film peel-off.

### Example 7

### Palladium Nanoparticle Precipitation

The palladate salts were soluble in methanol and stable for up to several days, forming a clear light brown solution. A CNT sample on glass was dipped in the palladate salt solution for ten seconds, which resulted in a 3% drop in Rₛ, and a 1% drop in transparency. A five minute dip resulted in a 7% drop in Rₛ, and a 22% drop in transparency. The resulting film was grey and metallic, indicating that palladium readily deposited onto the CNT film, but did not dramatically improve the conductivity of the film.

### Example 8

### Colloidal Gold Deposition onto CNT Networks

2 nm of colloidal gold were deposited onto CNT networks to determine if any benefit could be derived. 2 nm gold (1.5×10¹⁴ particles/mL) was purchased from Ted Pella and was used as an aqueous suspension or in 3:1 isopropanol:water. 2 nm gold differs from larger gold colloids in that it is a completely colorless suspension. It was attempted to dip coat CNT slides with 2 nm gold, but this resulted in an increase in sheet resistance of tens of Ohms without a change in transparency. A drop of 2 nm gold was dried on a CNT coated slide, which also resulted in an increased sheet resistance.

### Example 9

### Silver Nanoparticle Deposition onto CNT Networks

Silver metal was deposited onto CNT networks from silver nitrate solution. In the first instance, silver nitrate in water was used as a dip solution. In one experiment, a saturated solution of AgNO₃ in MeOH was used as a dip solution. A slide was sprayed to 285 Ohms/sq, then dipped for one minute in the solution. After drying, the sheet resistance measured 236.7 Ohms/sq, a 17% drop. After rinsing, the sheet resistance measured 241.5 Ohms/sq. Transparency did not change during processing. Like gold, silver nanoparticles precipitated spontaneously onto the nanotube network and improved conductivity.

Optical and scanning electron microscope examinations of the films showed the absence of bacteria, fungus, pathogens, microbes, or other forms of living microscopic biological matter.

### Example 10

### Aurate Salts Added to CNT Ink

Aurate salts were added to nanotube inks to observe their effects on RT performance and ink stability of stable nanotube dispersion. A 10 mM solution of HAuCl₄ in isopropanol and water was prepared and serially diluted to 1 mM and 0.1 mM HAuCl₄ solutions in isopropanol and water. Nanotubes were purified with an acid reflux. A nanotube concentration of 30 mg/L of ink at absorbance of 1.0 is assumed. The specified ratio of gold to nanotube is the weight ratio of gold metal. A sufficient amount of aurate solution was added to not heavily dilute the ink. Thus all samples had less than 500 mL of aurate solution added to 10 mL of ink with the exception of the 10:1 Au:SWNT sample, which had about 1.3 mL of aurate solution added. Ink was prepared in a large batch and divided into 10 mL aliquots. Each aliquot was sonicated for approximately a half a minute before spraying to disperse the ink.

The samples were spray deposited on glass slides to about 500 Ohms/sq. The sprayed samples had % T and Rs data measured, then renormalized to 500 Ohms/sq. The data is listed in the table below. All samples were examined for flocculation prior to and during spraying. All samples showed slight flocculation, which can be stabilized by controlling pH with ammonia, trimethyl amine, or by using a non-acidic gold salt.

| | | Au:SWNT | | |
|---|---|---|---|---|
| DAB code | RH code | Ratio | % T | Comments |
| 76-101-7 | 82-50-7 | Control | 94.3 | control, slight flocculation |
| 76-101-1 | 82-50-2 | 1:100 | 94.2 | moderate flocculation |
| 76-101-2 | 82-50-3 | 1:10 | 94.7 | slight flocculation |
| 76-101-3 | 82-50-4 | 1:5 | 94.6 | moderate flocculation |
| 76-101-4 | 82-50-5 | 1:1 | 94.4 | substantial flocculation |
| 76-101-5 | 82-50-6 | 2.5:1 | 53.2 | severe flocculation, |
| | | | | did not complete spraying |
| 76-101-6 | — | 10:1 | — | severe flocculation, |
| | | | | did not spray |

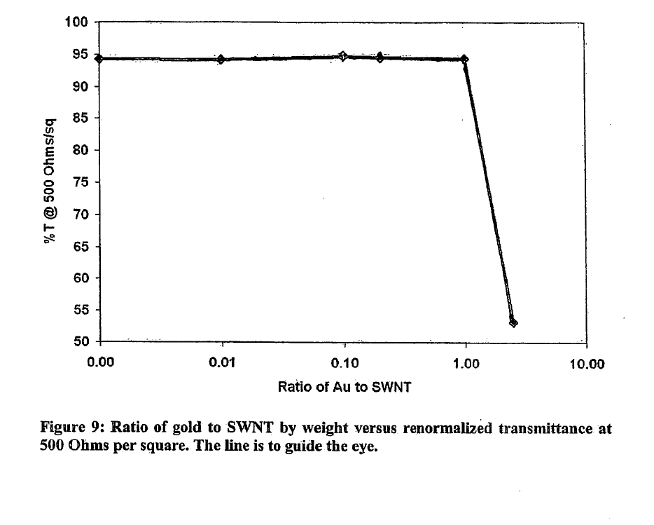

As can be seen from the table and from FIG. 9, the RT performance of the ink does not change from the control up to the tested value of equal weight percent of gold to nanotube. This change is in contrast to many additives, such as water soluble polymers, which cause a dramatic increase in sheet resistance at less than one percent of the nanotube weight.

Adding aurate salts to inks will cause gold particles to precipitate onto the nanotubes, as taught by Kim et al. (Angewandte Chemie Interantional Edition, 2006, 45, 104-107) and Choi et al. (Journal of the American Chemical Society, 2002, 124, 9058-9059). These results show that gold precipitates on dispersed nanotubes coated in surfactant and on a surface. In the case of a dispersion without surfactant, gold deposition will occur, as well. Thus, in the cases described above in this section, gold particles precipitate onto the nanotube sidewalls. If the deposition is sufficiently aggressive, then packing of nanotubes will be hindered substantially upon drying the dispersion. However, this was not observed, so the gold particles do not significantly hinder network formation below equal mass of gold and nanotube.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. The term comprising as used throughout this application includes the more limiting terms and phrases “consisting essentially of” and “consisting.” It is intended that the specification and examples be considered exemplary only with the true scope and spirit of the invention indicated by the following claims.

### REFERENCES

Kong et al. (J. Phys. Chem. C 2007, 111, 8377-8382)
Kim et al. (Angewandte Chemie Interantional Edition, 2006, 45, 104-107)
Choi et al. (Journal of the American Chemical Society, 2002, 124, 9058-9059)
U.S. Pat. No. 7,060,241, Coatings comprising carbon nanotubes and methods for forming same
US Patent Application, Publication No. 20060113510, Fluoropolymer binders for carbon nanotube-based transparent conductive coatings
US Patent Application, Publication No. 20050209392, Polymer binders for flexible and transparent conductive coatings containing carbon nanotubes
US Patent Application, Publication No. 20060057290, Patterning carbon nanotube coatings by selective chemical modification
US Patent Application, Publication No. 20050266162, Carbon nanotube stripping solutions and methods
US Patent Application, Publication No. 20040099438, Method for patterning carbon nanotube coating and carbon nanotube wiring
US Patent Application, Publication No. 20050221016, Methods for modifying carbon nanotube structures to enhance coating optical and electronic properties of transparent conductive coatings

1. An antimicrobial, electrically conductive and optically transparent film comprising single-walled carbon nanotubes and a sub-percolation threshold amount of metal particles that have a diameter below 200 nm, below 100 nm, below 50 nm or below 10 nm, wherein the metal particles impart significant electrical conductivity to the film.

2. The film of claim 1, wherein the metal is silver.

3. The film of claim 1, wherein the metal particles release ions that are toxic or static to growth or survival of pathogens, bacteria, or viruses.

4. The film of claim 1, wherein a surface of the film is toxic to pathogens, bacteria, or viruses.

5. An electrically conductive and optically transparent film, comprising a network of single-walled carbon nanotubes and a sub-percolation threshold amount of metal particles that have a diameter below 200 nm, wherein the metal particles impart significant electrical conductivity to the film.

6. The film of claim 5, wherein the carbon nanotubes form ropes, bundles, or combinations thereof.

7. The film of claim 5, wherein the metal particles decrease surface resistance of the network by between 10% and 20%, by between 10% and 50%, by between 30% and 50%, or by between 50% and 90%.

8. The film of claim 5, wherein the metal particles decrease visible light transmittance of the network by 10% or less, 5% or less, 1% or less, or 0.05% or less.

9. The film of claim 5, wherein the metal particles improve the network's sheet resistance stability, heat stability, UV stability, humidity stability, abrasion resistance, or combinations thereof.

10. The film of claim 5, wherein the metal particles improve mechanical connectivity, electrical connectivity, or combinations thereof, between the carbon nanotubes.

11. The film of claim 5, wherein the metal particles are gold particles and are from 1 to 200 nm in diameter, wherein sheet resistance of the film is less than 200 ohms/square, and wherein visible light transmittance of the film is greater than 80%.

12. A method of making a transparent conductive film comprising:
contacting a network of carbon nanotubes with a metal salt; and
applying an electrical potential to the network, wherein the electrical potential overcomes the chemical potential of the metal salt
resulting in a sub-percolation threshold amount of metal particles from the metal salt being deposited or precipitated onto the network, wherein the metal particles have a diameter of 200 nm or less and impart significant electrical conductivity to the film.

13. The method of claim 12, wherein the metal is gold, silver, palladium, platinum, copper, chromium, nickel, manganese, iron, aluminum, an alkaline earth metal, an alkali metal, a transition metal, a lanthanide, a poor metal, an actinide, or combinations thereof.

14. The method of claim 12, wherein the metal salt is in a solution comprising a polar solvent, a polar protic solvent, an alcohol, methanol, water, a mixture of alcohol and water, or combinations thereof.

15. The method of claim 12, wherein the electrochemical potential is an electrical reducing potential that facilitates deposition of the metal particles onto the network.

16. The method of claim 12, wherein the electrochemical potential is an electrical oxidative potential that inhibits the deposition of the metal particles onto the network.

17. The method of claim 12 wherein the contacting of the network with the solution comprises dipping, wet-coating, gravure printing, inkjetting, bubble jetting, spraying, or combinations thereof.

18. The method of claim 12, wherein the contacting of the network with the solution comprises depositing the metal particles in a pattern onto the network.

19. A colloidal dispersion comprising single-walled carbon nanotubes substantially formed into ropes and a metal salt in a solvent, wherein the metal salt is reduced by the carbon nanotubes to form metal particles that are deposited onto the carbon nanotubes, wherein the metal particles have a diameter below 200 nm.

20. The dispersion of claim 19, wherein the solvent is selected from the group consisting of a polar solvent, a polar protic solvent, an alcohol, methanol, water, and combinations thereof.

21. The dispersion of claim 19, wherein the metal salt is soluble in the solvent.

22. The dispersion of claim 19, wherein the metal particles and the carbon nanotubes are present in a weight percent ratio of 2.5:1, 1:1, 1:5, 1:10, or 1:100 metal particles to carbon nanotubes.

23. A method of producing an electrically conductive and optically transparent film comprising depositing the dispersion of claim 19 onto a substrate.

24. A method of removing impurities from a dispersion comprising single-walled carbon nanotubes, comprising:
adding a metal salt that preferentially precipitates onto said impurities and increases the density of the impurities;
removing the impurities onto which the metal salt precipitated by centrifugation and decantation, by filtration, by magnetic separation, or by a chemical reaction.

25. The method of claim 24, wherein the impurities comprise amorphous carbon, graphite, catalyst, damaged carbon nanotubes, organic particles, ionic contaminations, or combinations thereof.
